(19) United States
(12) Patent Application Publication
(10) Pub. No.: US 2012/0207604 A1
(43) Pub. Date: Aug. 16, 2012

(54) Incapsulated horizontal wind turbine

(76) Inventor: Gregory Lee Hobson, Topeka, KS (US)

(21) Appl. No.: 12/931,915

(22) Filed: Feb. 14, 2011

(51) Int. Cl. F03D 9/00

(52) U.S. Cl. 416/147; 416/170 R

(57) ABSTRACT

The incapsulated horizontal wind turbine is a wind powered sophisticated apparatus attached to a generator to produce electricity. A state of the art computer controlled diagnostic system that accepts data from wind sensors in the area or by satellite of the wind velocity and applies it to a computer program that has information for the best position to turn the aerodynamic wind blades with extending shaft that turn 360 degrees. To achieve the best speed for the generator or turbine to spin at different wind velocity and will adjust itself automatically for every 5 to 10 miles of wind change to get maximum power output of the generator or turbine at all times, also with the tower able to rise and lower the incapsulated horizontal wind turbine, to reach higher wind velocity higher in the sky to reinsure operations of wind generator to achieve electric output at all times.

This application claims benefit of U.S. provisional application No. 61/283, filed Feb. 17, 2010

### BACKGROUND OF INVENTION

Windmills and wind turbines are vary known in the art, serving a number of purposes including the operation of pumping and other mechanical devices and the generation of electricity. Traditionally windmills include a plurality of blades or vanes connected to a rotatable shaft, windmills have traditionally been spread across the world to perform functions from pumping of water, grinding grain and with respect to changing kinetic energy to electrical energy being coupled to other devices for generating and transmitting electrical power.

Wind power also can be generated by a horizontal windmill, the incapsulated horizontal wind turbine with computer diagnostic accepts data from wind sensor or satellite, that gives data of the wind velocity in the area also calculating the angle to position the aerodynamic wind blades with extending shaft to the most effective position for the maximum output of power at all times. With this ability we can control and regulate the amount of wind that forcibly contacts the aerodynamic wind blades, and controls the incapsulated horizontal wind turbine speed, so that a governor or speed control device is not necessary.

Because the turbine is incapsulated and not in the weather it will need less repairs and maintenance, incapsulated horizontal wind turbine also able to function in any direction the wind may blow. With the adjustable wind station tower that can rise the incapsulated horizontal wind turbine higher into the sky, where there is more wind the system will be able to function at all times.

### BRIEF SUMMARY OF THE INVENTION

In accordance with the present invention a horizontal windmill and electrical generator assembly comprising a vertical drive shaft mounted with the incapsulated horizontal housing to the top of the drive shaft of a electrical generator. With the aerodynamic wind blades with extending shaft able to turn 360 degrees in one direction and computer controlled to adjust itself automatically to different wind velocities every 5 to 10 miles of wind charge to achieve 100% use of the wind at all times, and maximum electrical output keeping the electrical generator within its desired speed range under a wide variety of wind conditions. Without any governor or speed control device. With pollution getting worse with acid rain causing corrosion at an alarming rate, the incapsulated horizontal wind turbine will need less repair and maintenance

Because the electrical generator is fully incapsulated and protected, no weather condition can effect or damage the electrical generator including acid rain causing corrosion. With the wind power station able to rise up and down to reach higher wind velocity or lowed if wind is to strong this will help keep the incapsulated horizontal wind turbine operating at all times. It will be lowered for maintenance and repair if needed, this is the state of the art future windmill or wind turbine computer controlled diagnostic system, the incapsulated horizontal wind turbine.

### BRIEF DESCRIPTION OF THE DRAWINGS

FIG. 1. Is a view of an incapsulated horizontal wind turbine constructed in accordance with the present invention.

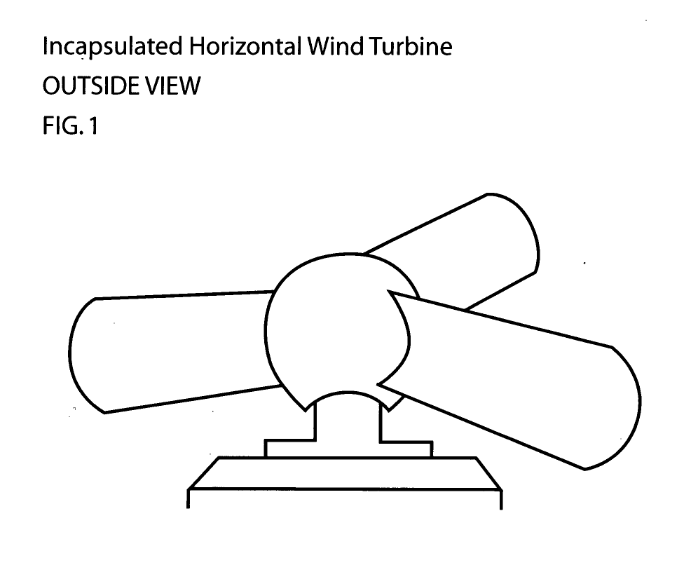

FIG. 2. Show a longitudinal sectional view of the inside of the incapsulated horizontal wind turbine, also view how the electrical generator or electrical turbine is location and assembled inside of the incapsulated horizontal housing.

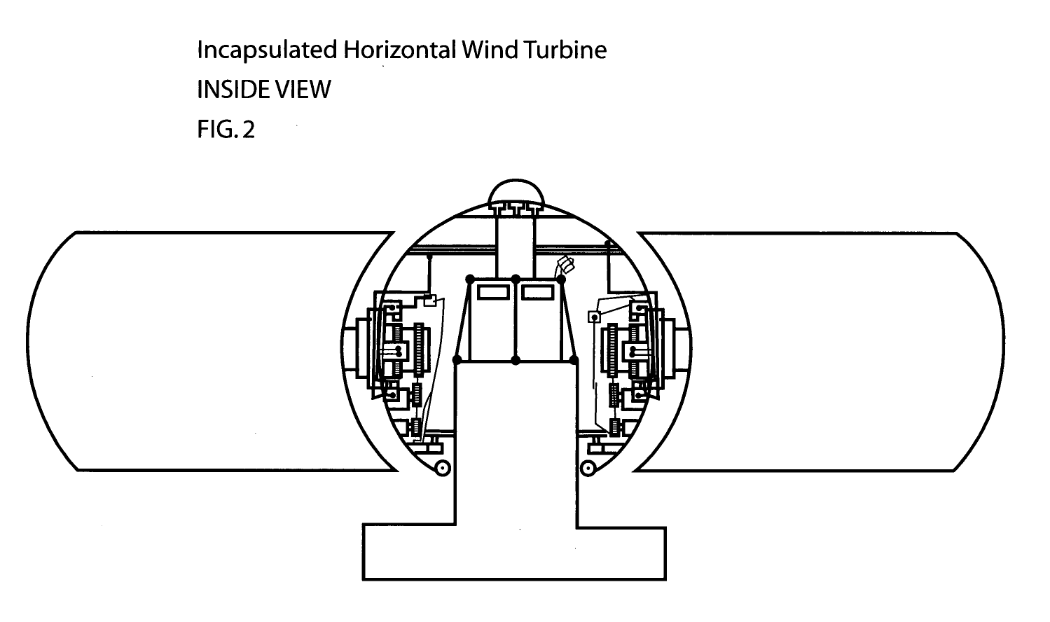

FIG. 3. Is a perspective view showing the incapsulated horizontal wind turbine of the present invention mounted on top of the wind power tower station.

FIG. 4. Show a fragmented, perspective view of the incapsulated horizontal wind turbine that will be used to help give a detailed description of the embodiment.

### DETAILED DESCRIPTION OF THE PREFERRED EMBODIMENT

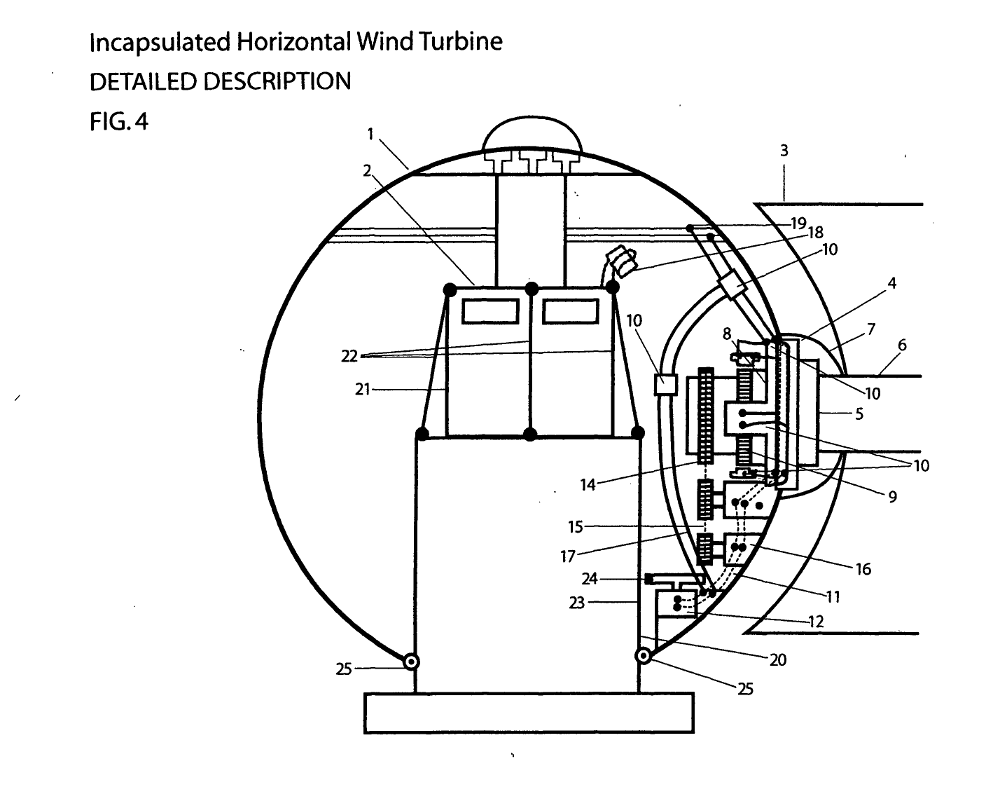

With reference to the drawing FIG. 4, Please note FIG. 4, is a fragmentary view that will help give a full description with respect to the embodiment and will become more apparent, also please note that only one aerodynamic wind blade with extended shaft 3, is needed for full description, because all three or more aerodynamic wind blades have the same parts and are assembled the same way. In compliance with constitutional purpose of the patents laws, “to promote the progress of science and useful arts” (article, section 8), applicant submit the following disclosure of the Embodiment.

With reference to the drawing FIG. 4, there is illustrated a preferred form of a rotatable windmill or wind turbine depicted generally by reference numeral 1. The windmill or wind turbine as illustrated includes a rotatable housing numeral 1, the inside top rotatable housing numeral housing 1, of the drawing FIG. 4, the incapsultaed horizontal housing is pivotally balanced mounted to the top of the drive shaft of numeral 2, the wind turbine. The incapsulated horizontal 1 could be any shape, but it is mounted round for aerodynamic reasons purposefully, the molded round incapsulated horizontal housing 1, has three or more bearings 4 imbedded into the structure material or they could be mounted to and bolted onto the incapsulated horizontal housing 1. A hole must be cut out of the incapsulated horizontal housing 1, the same size as the hole in the bearing 4, so that the aerodynamic wind blades with extended shaft 3, can be inserted into the bearing 4 and through the incapsulated horizontal housing 1, about 0.5 feet to 2 feet.

These bearings 4, are placed around at equal distances around the center of the incapsulated horizontal housing 1, just by turning or spinning the aerodynamic wind blades with extending shaft 3, at different positions around a circle the aerodynamic wind blades 3, have the capacity to spine 360 degrees the circumference of a circle. With this ability we can control and regulate the amount of wind that forcibly contacts the aerodynamic wind blades with extending shaft 3, the speed in which the incapsulated horizontal wind turbine 1, spines to achieve the most efficient and accurate rotational operational speed for maximum output of electrical power at all times.

So that a governor or speed control device is not necessary, the aerodynamic wind blades with extending shaft 3, are made very strong to support the blades, also there is foam inside the blades for extra support of the blades so that the aerodynamic wind blades with extending shaft 3, can withstand the forcible contact of high wind volisity. The aerodynamic wind blades with extending shaft 3, run the whole length of the aerodynamic wind blades with extending shaft 3, two sides are longitudinally extended away from the incapsulated horizontal housing 1, the other side extending into the wind, the final side of the aerodynamic wind blades with extending shaft 3, come close but does not make contact to the incapsulated horizontal housing 1. There is a large spacer 5, placed onto the shaft 6, and positioned and locked down, the spacer will stop the aerodynamic wind blades with extending shaft 3, from hitting the incapsulated horizontal housing 1, and from going more than what is needed through the bearing 4, and into the incapsulated horizontal housing 1.

There are rubber covers 7, that goes over the bearing 4, and round the aerodynamic wind blade with extending shaft 3, to keep water, dust . . . etc. out of the incapsulated horizontal wind turbine 1, on the opposite side of the incapsulated horizontal housing 1, through the bearings 4. The aerodynamic wind blades with extending shaft 3, fits very tightly into the bearing 4, then another large spacer 8, and a large gear is placed onto the shaft, both the spacer 8, and gear 9, are locked down onto the shaft 6, very tightly and are not able to move so that the aerodynamic wind blades with extending shaft 3. Is secured inside the incapsulated horizontal housing 1, and cannot slip out of the bearing 4, or the incapsulatd horizontal housing 1, also the large gear 8, has a locking mechanism 10, that will not allow the aerodynamic wind blades with extending shaft 3 to spine.

A computer control the locking 9, of the aerodynamic wind blades with extending shaft 3, using electrical battery operated locking and unlocking switches 10, automatically like a remote control that locks and unlocks a car door, all of the aerodynamic wind blades with extending shaft 3, are locked and unlocked 10, at the same time, on the incapsulated horizontal wind turbine 1, so that they can all be turned at the same time on the incapsulated horizontal wind turbine 1. So that they can all be turned at the same time the electrical locking and unlocked mechanism 10, are power by battery 11, and connected by wire to a generator 12, that keeps the batteries charged for the whole incapsulated horizontal housing 1. There is another ring gear on the extending shaft 14, of the aerodynamic wind blades 3, near the end of the shaft 6, this ring gear is connected with chain 15, with two drive shaft gears 17, of two battery operated electrical motors 16, they both can operate and turn the aerodynamic wind blades with extending shaft 3, 360 degrees but one electrical motor 16, is used for a backup system. In case of a emergency system failure, these motors 16, are mounted on the inside of the incapsulated horizontal housing 1, these electrical battery power motors 16, are adjusted and operated to turn on an off, an move at the same time all of the aerodynamic wind blades with extending shaft 3.

They move at the same angle or position and move in one direction and do not move backwards, there is a computer control room on the ground, were an electrical power meter is located that reads the amount of electricity or watts of electricity that have been manufactured. A computer diagnostic program is designed to calculate and calibrate the best angle and position of the aerodynamic wind blades with extending shaft 3, with data from satellite and wind sensors and with up to date wind velocity data. The aerodynamic wind blades with extending shaft 3, the computer will use photosensitive 19, and photo emissive 18, diodes or varactors diodes to send or receive signals to turn on the electrical battery operated motor 16, and turn on the aerodynamic wind blades with extending shaft 3, automatically to the best position. Just like an electronic tuning for television receiver, the computer calculates the data and automatically calibrates the position at any given wind velocity and automatically adjust itself in low or high winds velocities every 5 to 10 miles an hour of wind

If the wind velocity gets to strong the computer will automatically turn the aerodynamic wind blades 3, fully horizontal and cut the wind off the aerodynamic wind blades 3, and the incapsulated horizontal wind turbine 1, slow down and will almost come to a complete stop. The spindle bushing 20, has designed very strong and has numerous purposes, it has a large round support base with a hole in the center with a cylinder shaped part circling around the center of the hole, this part is molded inside of the cylinder are spacers formed at the bottom of the cylinder. And run in a star like pattern, and goes up to the inside wall of the cylinder the star like pattern design allows air to flowing in and out and around the wind turbine to help it stay cool, these spacers are covered with a heavy rubber and glued down and screwed down to keep them in place.

The wind turbine 21 is then lowered down into the center cavity of the cylinder, the spindle bushing 20, with the rubber on top of the spacer. It will be designed for a very tight fit for support, this will help stop vibrations and noise, the spindle bushing 20, comes up to about halfway the length of the wind turbine 21, setting it up in a vertical position and supporting the wind turbine 21, and the incapsulated horizontal housing 1, for extra support we attach some strong cable 22, from the top edge of the wind turbine 21, to the lower top edge of the spindle bushing. At different locations around both edges of the wind turbine 21, and the spindle bushing 20, also the bottom of the spindle bushing 20, is bolted down to a building pole or tower for more support and keep the incapsulated horizontal wind turbine 1, in place. At the bottom of the incapsulated horizontal housing 1, there are generators 23, mounted to the incapsulated horizontal housing with rubber wheels 24, that ride around the spindle bushing 20, creating power to charge the batteries 11, that power the electrical power motor 16, that turns the aerodynamic wind blades with extending shaft 3, also powers the electrical lock and unlocking switches 10, and the computer tells them when to come on and off and position the aerodynamic wind blades with extending shaft 3.

There are brackets that hold heavy rubber wheels 25, that also spine around or roll around on the side of the spindle bushing 20, to keep stabilize the incapsulated horizontal housing and are very easy to remove and replace. A hydraulic breaking system its used to bring the incapsulated horizontal wind turbine to a complete stop, in case it needs repairs or major emergency bushing base, it has a very heavy rubber bushing on top that rides along the lower edge outside applying pressure like a jack, and bring the incapsulated horizontal wind turbine 1, to a stop.

The computer control room is built on the ground where the computer and the electrical power meter is located they will read how much power is produced, the electrical power cables and wires run from the wind turbine and down through the center core opening of the spindle bushing, and run down through the inside of the pole to the computer control room and into the computer, and into the power reading meter, and out to the client to be used. The incapsulated horizontal wind turbine can be made in small, medium, or large sizes. More aerodynamic wind blades with extending shaft 1 may be used if needed for low wind velocities, there a second option to use solar power generators system. The solar panel is mounted on top of the incapsulated horizontal turbine 1, and run wires through a hole made into the incapsulated horizontal housing, to the batteries 11, to be charged.

Then to the electrical power motor 16, that turn the aerodynamic wind blades with extending shaft 3, 360 degrees, and keep one electrical power motor 16, on the generator power system 12, for a emergency backup system and power to the switches 10. Please note, all of the aerodynamic wind blades with extending shaft 3, are designed in the same manor with all the same parts to turn the aerodynamic wind blades with extending shaft 3.

360 degrees to operate the incapsulated horizontal wind turbine 1, is designed to function in any direction and at an velocity the wind blows, and putout maximum electrical power at all times. My adjective is to help mankind, and save the world from pollution, global worming that effect everything in the world, a clean none polluting, a low cost system easy to maintain and repair. The incapsulated horizontal wind turbine energy system, by using this type of system we will not have to place then all over the planet, that takes up land and are eye sores very expensive to operate and repair, and do not function all the time. Just a few incapsulated horizontal wind turbine are needed, one for a backup unit in case one needs repair because of the ability to control the speed of the turbine in high or low wind velocity and because it function in any direction the wind blows, and is placed higher in the sky where there is wind all the time. Incapsulated horizontal wind turbine 1, will function at all times and will supply electrical energy.

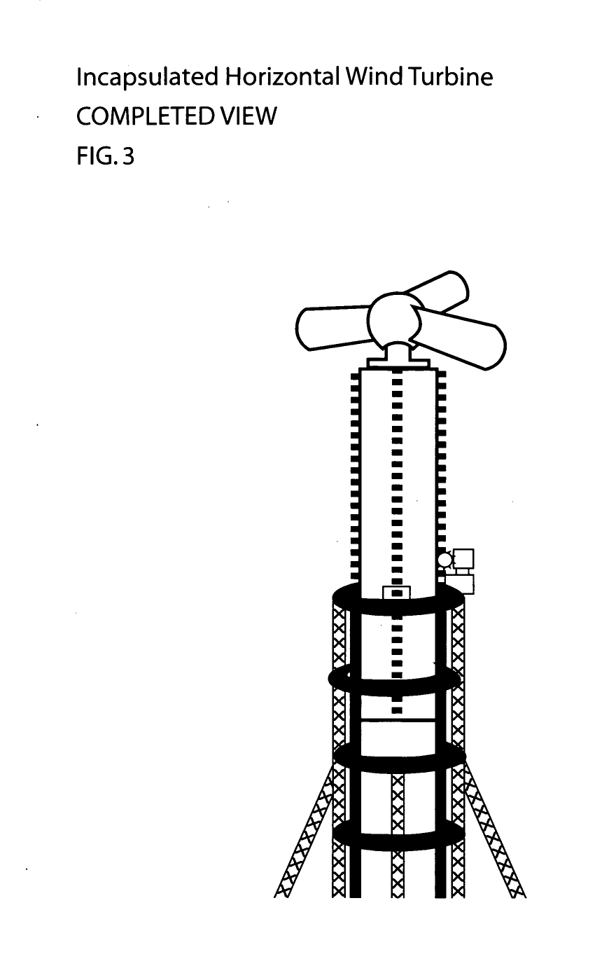

A small example of how the incapsulated horizontal wind turbine and wind power station will look after being built, it is able to rise up and down to reach higher wind velocities, and lowered for maintenance and repair of needed, and is designed to operate at all times see drawing FIG. 3 attached.

The invention claimed is:

1. A incapsulated horizontal wind turbine comprising: a incapsulated horizontal wind generator comprising: a incapsulated horizontal windmill comprising: a generally vertical drive shaft mounted for rotation about a vertical axis, a incapsulated horizontal housing, wherein said wind turbine in inserted up through the bottom of said incapsulated horizontal housing, wherein said wind turbine is located inside of said incapsulated horizontal housing, wherein the top of said drive shaft of said wind turbine is centered and pivotally balanced, and said mounted to the inside top of said incapsulated horizontal housing, wherein this will help give the said incapsulated horizontal housing, perpetual spinning motion, wherein the said incapsulated horizontal housing its molded round material is structured for aerodynamic reasons purposefully, including three or more large bearing with holes in the center and could be imbedded into said molded material or screw and bolted down at equal distances apart,
centered and balanced around said incapsulated horizontal housing, wherein a hole must be cut out of the said incapsulated horizontal housing the same size of the said hole in the said mounted bearing, wherein three or more aerodynamic wind blades with extending shaft can be inserted into the said incapsulated horizontal housing, wherein said aerodynamic wind blades with extending shaft are made very strong to support the blade, including foam inside of the blade for extra support of the blade, so that it can withstand the forcible contact of high wind velocity, wherein two side, are longitudinally extend away from the said incapsulated horizontal housing, wherein the other side extending into the wind, wherein the final side of the said aerodynamic wind blade with extending shaft comes close but does not make contact to the said incapsulated horizontal housing, wherein just the extended shaft is inside of said incapsulated horizontal housing, wherein each said aerodynamic wind blade with extending shaft has two large spacers secured down tightly so they can't move,
wherein said one spacer is placed onto said aerodynamic wind blade before it is inserted into said bearing and mounted to said incapsulated horizontal housing, wherein this will help keep said aerodynamic wind blade and said incapsulated horizontal housing from hitting each other, wherein the said aerodynamic wind blade with extending shaft is said inserted through the said bearing mounted on said incapsulated horizontal housing, wherein said extending shaft is inside of said incapsulated horizontal housing, wherein said second large spacer is placed onto the said extending shaft and said secured down tightly inside of said incapsulated horizontal housing,
wherein both said spacers help secure the said aerodynamic wind blade with extending shaft from slipping out of the said incapsulated horizontal housing, wherein the said mounted bearing to said incapsulated horizontal housing gives the said aerodynamic wind blade with extending shaft the ability to spin 360 degree's around, wherein two large gears are mounted down securely so they don't move inside of the said incapsulated horizontal housing onto the said aerodynamic wind blade with extending shaft, wherein four electrical lock and unlocking switches create a said locking and unlocking mechanism that is mounted on the inside of said incapsulated horizontal housing at equal distances around said aerodynamic wind blade with extending shaft, wherein said locking and unlocking mechanism interact with said first large gear on the said aerodynamic wind blade with extend shaft for the purpose of locking and unlocking said aerodynamic wind blade with extending shaft, including a rechargeable battery mounted to the inside of said incapsulated horizontal housing, wherein sensors, wiring and a small generator to charge the battery is also mounted inside of the said incapsulated horizontal housing so that the said aerodynamic wind blade can be locked and unlocked automatically, wherein the said second large gear interacts with two electrically battery operated motors with main shaft and gear that are also mounted inside of the said incapsulated horizontal housing, wherein one said electrically battery operated motor with said main shaft and gear is used for a backup in case one is damaged or wears out, wherein the said second large gear and the said two electrically battery operated motors are connected with a chain, wherein will give the ability to turn the said aerodynamic with blades with extending shaft to any given position around 360 degree's automatically in one direction, including said wiring and small generator to charge battery and help power said sensors, wherein please note all said three or more aerodynamic wind blades with extending shaft have the same assembly and said parts, wherein the said spindle bushing is designed very strongly and has numerous purposes, wherein a molded star like spacing pattern inside of said spindle bushing to help air flow in and out to keep said wind turbine cool, wherein there are two hole molded into said spindle bushing one large said hole inside of cylinder shaped part of said spindle bushing and a smaller said hole on the support base at the bottom of said spindle bushing, wherein everything is molded as one part,
wherein said molded star like spacing pattern starts at the edge of said small hole in support base runs across the said support base in said star like spacer pattern up the said large hole in the said cylinder wall running from the said star like pattern in the bottom of the said support base, wherein these said star like pattern spacers over covered with heavy rubber and glued down and screwed down to keep them in place, wherein the said star like pattern help stop vibration and noise and the spacing creates a channel for air flow to keep the turbine cool, wherein said wind turbine is tightly inserted into said spindle bushing, wherein the said spindle bushing comes up to about halfway or little over halfway the length of the said wind turbine, wherein setting the said wind turbine in a vertical position, wherein said support base will support the said wind turbine from falling over,
including said incapsulated horizontal housing, wherein for extra support we attach some strong cables from the top edge of said wind turbine to the top edge of said spindle bushing at different locations around both said spindle bushing and said wind turbine inside of said incapsulated horizontal housing, wherein the bottom of the said spindle bushing is bolted down to building, pole or tower for more support to keep said incapsulated horizontal wind turbine secure in place, wherein there are brackets that hold heavy rubber wheels that also spin around or the side of said spindle bushing to help stabilize the said incapsulated horizontal housing attach to the bottom of said incapsulated horizontal housing, wherein a hydraulic or a jack like system is used to bring the said incapsulated horizontal wind turbine in case of needed repairs or major emergency to a complete stop, wherein the computer control room is built on the ground and the electrical power meter is located also, it reads how much power is produced and billed to the customer,
wherein in photosensitive and photoemissive diodes send and receive signals to turn on and off the said electrical batteries, that control and turn said aerodynamic wind blades with extending shaft from the said computer to the best position to achieve the best speed for the said wind turbine, to spin and said adjust itself to the said best angle for different said wind velocities,
wherein said computer accepts data from the wind sensor or satellite of the wind velocity in the area and applies to the computer program for the best angle to turn the said aerodynamic wind blades with extended shaft, that can turn said 360 degrees at any given wind velocity automatically, in one direction and adjusts itself every 5 to 10 miles an hour of said wind velocity changes automatically, an change in high or low winds this computer diagnostics system, where in the electrical power cables and wires from the sensor on top of the said wind turbine go down though the said spindle bushing, wherein the said computer sends signals from the computer to the sensor to said unlock or lock said aerodynamic wind blades with extended shaft, wherein set to said the perfect position or angle of the said aerodynamic wind blade with extended shaft to be turned between said 0 to 360 degrees at any given said wind velocity for maximum output of electrical power all the time wherein the said signal can come from satellite or wind sensor to the computer automatically or manually by computer in case of emergency, wherein said state of the art computer diagnostic system said incapsulated horizontal wind turbines, wherein said batteries or can be change by solar panel mounted of top of said incapsulated horizontal wind turbine on outside of said housing, Wherein the said horizontal wind turbine is mounted onto a wind power tower station and can rise up and down to reach higher wind velocities or lowered if wind conditions to strong also lowered for maintenance and repairs if needed also uses large motor to raise tower,

2. A incapsulated horizontal windmill according to claim 1, wherein said windmill is rotatable about it vertical axis,

3. A incapsulated horizontal windmill according to claim 1, wherein said windmill further includes means for couplings said incapsulated horizontal housing to a power generator,

4. A incapsulated horizontal windmill according to claim 2, wherein said means of coupling is power transfer shaft,

5. A incapsulated horizontal windmill according to claim 1, wherein the angles of the said aerodynamic wind blades with extended shaft are computer controlled,

6. A incapsulated horizontal windmill according to claim 1, wherein the said aerodynamic wind blades with extended shaft can said automatically adjust itself for every said 5 to 10 miles of wind velocity changes,

7. A incapsulated horizontal wind turbine according to claim 1, wherein said aerodynamic wind blades with extended shaft can turn 360 degrees,

8. A incapsulated horizontal windmill according to claim 1, wherein using wind sensor or satellite to receive data, of wind velocity,

9. A incapsulated horizontal windmill according to claim 1, wherein the said spindle bushing hold the generator in a vertical position secures and stabilizes the wind turbine,

10. A incapsulated horizontal windmill according to claim 1, wherein said photosensitive and photoemissive design to send or receive said signal to turn on or off the said electrical battery operated motor,

11. A incapsulated horizontal windmill according to claim 1, wherein said signal turn on or off and turn the said aerodynamic wind blades with extending shaft, to said automatically to the superative position,

12. A incapsulated horizontal windmill according to claim 1, wherein the said horizontal wind turbine is mounted onto a wind power tower station,

13. A incapsulated horizontal windmill according to claim 1, wherein power tower station can lowered if wind conditions to strong also lowered for maintenance and repairs,

14. A incapsulated horizontal windmill according to claim 1, wherein if needed also uses large motor to rise tower or lower tower to reach higher wind velocities,

15. A incapsulated horizontal windmill according to claim 1, wherein said solar panel of said incapsulated horizontal wind turbine can be used to charge the rechargeable batteries.
